(19) United States
(12) Patent Application Publication
(10) Pub. No.: US 2011/0264537 A1
(43) Pub. Date: Oct. 27, 2011

(54) METHOD FOR BILLING FOR SEARCH ADVERTISEMENT BASED ON PUBLICATION RATIO, SYSTEM AND COMPUTER-READABLE RECORDING MEDIUM

(75) Inventors: Ki Oh Kwon, Yongin-si (KR); Yu Won Kim, Seongnam-si (KR); Won Sook Noh, Seoul (KR); Woong Sup Shin, Seoul (KR); Woo Sung Lee, Yongin-si (KR); Min Seon Jeon, Seoul (KR); Seo Jin Han, Seoul (KR)

(73) Assignee: NHN BUSINESS PLATFORM CORPORATION, Seongnam-si (KR)

(21) Appl. No.: 13/119,411

(22) PCT Filed: Sep. 18, 2009
(86) PCT No.: PCT/KR2009/005316

§ 371 Date: Jun. 2, 2011

(30) Foreign Application Priority Data
Sep. 18, 2008 (KR) 10-2008-0091807
Sep. 18, 2008 (KR) 10-2008-0091808

(51) Int. Cl. G06Q 30/00

(52) U.S. Cl. 705/14.71; 705/14.69

(57) ABSTRACT

Disclosed herein are a method, a system, and a computer-readable recording medium for performing charging for a search advertisement based on a publication ratio thereof. The method for performing charging for a search advertisement based on a publication ratio thereof includes: calculating the publication ratio of the search advertisement to a plurality of users, the publication ratio substantially indicating a ratio between the number of search advertisement published to users recognized as belonging to a first group and the number of search advertisement published to users recognized as belonging to a second group; calculating each of the charging amounts for the search advertisement published to the users recognized as belonging to the first group and the search advertisement published to the users recognized as belonging to the second group; calculating a final charging amount based on the publication ratio and each of the calculated charging amounts; and performing charging for an advertiser of the search advertisement using the final charging amount.

### TECHNICAL FIELD

The present invention relates to a method, a system, and a computer-readable recording medium for performing charging for a search advertisement based on a publication ratio thereof. More particularly, the present invention relates to a method, a system, and a computer-readable recording medium for performing charging for a search advertisement based on a more advanced scheme by allowing an advertisement cost for the search advertisement to be determined based on time during which the search advertisement may be published and allowing a publication ratio of the search advertisement to be considered in determining the advertisement cost under each situation in which the search advertisement is published according to different policies under different situations.

### BACKGROUND

Recently, in accordance with the generalization of Internet usage, users have been capable of obtaining various information through Internet searches. That is, the users have been capable of searching various contents related to news, a knowledge, a game, a community, or the like, by accessing an Internet search site through a terminal device such as a personal computer, or the like, capable of accessing the Internet.

As described above, in accordance with the generalization of information obtaining through the Internet search, a search advertisement providing an advertisement related to a search clue (for example, a search keyword, a search category, or the like) input from the users through the search site has been recently activated. Here, the search advertisement is an advertisement method of allowing advertisement information such as a uniform resource locator of an advertiser, a one-line advertisement message, an image advertisement, or the like, to be published at a specific position on a search result page in the case in which the users perform a search with a specific search clue using a search engine. In addition, according to the search advertisement, since the advertisement is provided only to the users performing the search with a search clue related to a specific advertisement, rather than being unconditionally provided to a number of unspecified users, a targeted advertisement may be provided only to potential customers relatively more likely to use a product or a service provided by the advertiser. Therefore, the search advertisement has been recently prominent significantly, and a usage range thereof has gradually increased.

Meanwhile, the main concern of an advertiser paying a cost for the search advertisement is whether or not he/she may allow the users to effectively experience his/her advertisement within a limited advertisement budget. Therefore, several methods of charging a cost for search advertisement have been developed in order to satisfy the need of the advertiser. As specific charging methods, there are a cost per millennium (CPM) method in which an advertisement cost is calculated according to a number of advertisement exposures to users, a cost per action (CPA) method in which an advertisement cost is calculated according to an action result of users, a cost per click (CPC) method in which an advertisement cost is calculated according to a number of selections and clicks of advertisement information (that is, a link of a web page of an advertiser, or the like) by users, or the like.

Meanwhile, the search advertisement is generally sold through auction between a number of advertisers and an advertisement provider. Also, in the action of the search advertisement, the above-mentioned CMP method, CPA method, CPC method, or the like, may be used. For example, in a case in which a bidding price is determined according to the CPC method, an advertiser may determine the bidding price with respect to ‘an advertisement cost to be paid for per one click’ generated for the search advertisement.

The above-mentioned charging and auction method according to the related art is reasonable in that the advertisement cost is charged according to a generation degree of charging bases (an advertisement exposure, an advertisement information click, or the like). However, it is a disadvantage in that a number of advertisement exposures or a number of clicks for advertisement information has a direct influence on a charging amount for the search advertisement. For example, there is often a case in which abnormal many invalid exposures or invalid clicks that do not generate a substantial advertisement effect for a specific search advertisement occur. In this case, the invalid exposures or the invalid clicks are reflected in the charging amount without any filtering, such that the advertisement cost that is to be paid for by the advertiser may be excessively increased. Actually, in a search advertisement industry, acts of abusing the above-mentioned problem to allow a search advertisement of a competitor to be meaninglessly exposed several times or allow advertisement information on the search advertisement of the competitor to be meaninglessly exposed several times are frequently generated. Economic loss by the advertiser due to the invalid exposure or the invalid click has increased day by day. When the economic loss of the advertiser due to the invalid exposure or the invalid click continues, reliability of the advertiser for an advertisement provide may be impaired, such that a search advertisement market may also be reduced.

As an attempt to solve the problem, an applicant of the present invention has suggested a technology of allowing an advertisement cost for a search advertisement to be determined based on time during which the search advertisement is published in Korea Patent Application No. 2008-91074 filed on Sep. 17, 2008, the entire disclosure of which is incorporated herein by reference. However, it was difficult to flexibly cope with a case in which a single search advertisement is published according to different policies under different situations such as a case in which whether or not the advertisement is published is determined or an advertisement cost is differently determined, according to characteristics of the user (for example, age, sex, or the like, of the user), an accessing environment of the user (for example, whether or not the user passes through an adult authentication process, or the like), or a region in which the user is located, or the like, using only the above-mentioned technology.

### SUMMARY

The present invention has been proposed to solve all of the above-mentioned problems.

An object of the present invention is to provide a new search advertisement model allowing an advertisement cost to be determined based on a publication ratio of the search advertisement under each situation in the case in which the search advertisement is published according to different policies under different situations.

Another object of the present invention is to allow a reasonable advertisement cost to be charged to an advertiser through the new search advertisement model.

According to an aspect of the present invention, there is provided a method for performing charging for a search advertisement based on a publication ratio thereof, the method including: calculating the publication ratio of the search advertisement to a plurality of users, the publication ratio substantially indicating a ratio between the number of search advertisement published to users recognized as belonging to a first group and the number of search advertisement published to users recognized as belonging to a second group; calculating each of the charging amounts for the search advertisement published to the users recognized as belonging to the first group and the search advertisement published to the users recognized as belonging to the second group; calculating a final charging amount based on the publication ratio and each of the calculated charging amounts; and performing charging for an advertiser of the search advertisement using the final charging amount.

According to another aspect of the present invention, there is provided a method for performing charging for a search advertisement based on a publication ratio thereof, the method including: calculating the publication ratio of the search advertisement to a plurality of users, the publication ratio substantially indicating a ratio between the number of search advertisement published to users recognized as belonging to a specific group and recognized as not belonging to the specific group and the total publication number of search advertisement; calculating the charging amounts for the search advertisement published to the users recognized as belonging to the specific group and recognized as not belonging to the specific group; calculating a final charging amount based on the publication ratio and the calculated charging amounts; and performing charging for an advertiser of the search advertisement using the final charging amount.

According to another aspect of the present invention, there is provided a system for performing charging for a search advertisement based on a publication ratio thereof, the system including: a log analyzing unit configured to calculate the publication ratio of the search advertisement to a plurality of users, the publication ratio substantially indicating a ratio between the number of search advertisement published to users recognized as belonging to a first group and the number of search advertisement published to users recognized as belonging to a second group; a charging amount calculating unit configured to calculate each of the charging amounts for the search advertisement published to the users recognized as belonging to the first group and the search advertisement published to the users recognized as belonging to the second group and calculating a final charging amount based on the publication ratio and each of the calculated charging amounts; and a charging processing unit configured to perform charging for an advertiser of the search advertisement using the final charging amount.

According to another aspect of the present invention, there is provided a system for performing charging for a search advertisement based on a publication ratio thereof, the system including: a log analyzing unit configured to calculate the publication ratio of the search advertisement to a plurality of users, the publication ratio substantially indicating a ratio between the number of search advertisement published to users recognized as belonging to a specific group and recognized as not belonging to the specific group and the total publication number of search advertisement; a charging amount calculating unit configured to calculate the charging amounts for the search advertisement published to the users recognized as belonging to the specific group and recognized as not belonging to the specific group and calculating a final charging amount based on the publication ratio and the calculated charging amounts; and a charging processing unit configured to perform charging for an advertiser of the search advertisement using the final charging amount.

According to another aspect of the present invention, there is provided a method for performing charging for a search advertisement based on a publication ratio thereof, the method including: calculating the publication ratio of the search advertisement to a plurality of users, the publication ratio substantially indicating a ratio between the number of search advertisement published to users recognized as being located in a first region and the number of search advertisement published to users recognized as being located in a second region; calculating each of the charging amounts for the search advertisement published to the users recognized as being located in the first region and the search advertisement published to the users recognized as being located in the second region; calculating a final charging amount based on the publication ratio and each of the calculated charging amounts; and performing charging for an advertiser of the search advertisement using the final charging amount.

According to another aspect of the present invention, there is provided a system for performing charging for a search advertisement based on a publication ratio thereof, the system including: a log analyzing unit calculating the publication ratio of the search advertisement to a plurality of users, the publication ratio substantially indicating a ratio between the number of search advertisement published to users recognized as being located in a first region and the number of search advertisement published to users recognized as being located in a second region; a charging amount calculating unit calculating each of the charging amounts for the search advertisement published to the users recognized as being located in the first region and the search advertisement published to the users recognized as being located in the second region and calculating a final charging amount based on the publication ratio and each of the calculated charging amounts; and a charging processing unit performing charging for an advertiser of the search advertisement using the final charging amount.

According to another aspect of the present invention, there are provided another method, system, computer-readable recording medium having a computer program recorded therein, for implementing the present invention, the computer program executing the method.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view schematically showing a configuration of the entire system for performing auction and charging for a search advertisement based on time during which the search advertisement is published according to an exemplary embodiment of the present invention;

FIG. 2 is a view showing an internal configuration of a search advertisement system according to an exemplary embodiment of the present invention in detail;

FIG. 3 is a view illustratively showing a classification standard of search keywords and advertiser information;

FIG. 4 is a view illustratively showing an aspect in which publication ranks of advertisements are determined according to bidding prices and expected advertisement effects of advertisers;

FIG. 5 is a view illustratively showing a result in which different search advertisements are published for each situation with respect to a single search keyword;

FIG. 6 is a view showing an internal configuration of a search advertisement system 200 according to an exemplary embodiment of the present invention in detail;

FIG. 7 is a view showing an example of defining a regional condition in which search advertisements of advertisers are published; and

FIG. 8 is a view illustratively showing a publication result of search advertisements provided corresponding to a search keyword input by a user or regional information of the user.

### DETAILED DESCRIPTION OF EMBODIMENTS

Exemplary embodiments of the present invention will be described in detail with reference to the accompanying drawings. These exemplary embodiments will be described in detail for those skilled in the art in order to practice the present invention. It should be appreciated that various embodiments of the present invention are different but do not have to be exclusive. For example, specific shapes, configurations, and characteristics described in an exemplary embodiment of the present invention may be implemented in another exemplary embodiment without departing from the spirit and the scope of the present invention. In addition, it should be understood that position and arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. The similar reference numerals will be used to describe the same or similar functions throughout the accompanying drawing.

Hereinafter, exemplary embodiments of the present invention will be described in detail with reference to the accompanying drawings so that those skilled in the art may easily practice the present invention.

In the present description, a search advertisement calls collectively an advertisement method of allowing advertisement information such as a uniform resource locator of an advertiser, a one-line advertisement message, an image advertisement, or the like, to be published at a specific position on a search result page in the case in which users perform a specific search with a specific search clue (for example, a search keyword, a search category, or the like) using a search engine, or an advertisement using the same. Particularly, the search advertisement described in the present description should be interpreted in the widest sense, including a keyword advertisement in which an advertisement related to a search keyword input by users is published together with a search result provided by a search site according to the search keyword.

In addition, in the present description, charging calls collectively a series of process of charging a cost to an advertiser at the cost of search advertisement publication for the advertiser. Particularly, the charging advertisement described in the present description should be interpreted in the widest sense, including all of a cost per millennium (CPM) method in which an advertisement cost is calculated according to the number of advertisement exposures to users, a cost per action (CPA) method in which an advertisement cost is calculated according to an action result of users, a cost per click (CPC) method in which an advertisement cost is calculated according to the number of selections and clicks of an advertisement by users, a cost per time (CPT) method in which an advertisement cost is calculated based on a time during which an advertisement is published, or the like.

In the present description, the CPT method indicates a new charging method of allowing an advertiser to bid for a predetermined search keyword and a predetermined time (period) at a bidding price set by him/her in order to publish his/her search advertisement at a predetermined position on a search result page, allowing an advertisement to be published whenever users perform search with the search keyword during the time, and allowing an advertisement cost due to the advertisement publication to be basically determined according to a bidding price and a time during which the advertisement is published.

According to the CPT method, a plurality of search advertisements (of different advertisers if there are many advertisers) by a single search keyword may be basically arranged and displayed on a search result page according to an amount of a bidding price (according to a high amount rank) for the respective advertisements. Here, other variables (for example, a class of an advertiser, an accumulative charging amount for the advertiser) in addition to the amount of the bidding price may be referenced in determining a position of a search advertisement.

Although the bidding is performed for a single search advertisement, it may be separately treated for each time period (in this case, the bidding price may be changed for each time period according to the selection of an advertiser). Arranged positions of search advertisements may be changed for each time period.

In spite of the above description, the CPT method according to the present invention is not limited to the above-mentioned contents. A right for all the CPT methods disclosed or implied in a detailed description below may be considered as pertaining to the present applicant.

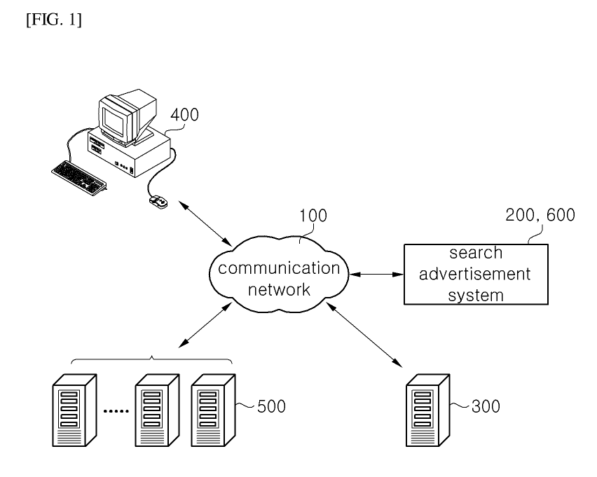

FIG. 1 is a view schematically showing a configuration of the entire system for performing auction and charging for a search advertisement based on a time during which the search advertisement is published according to an exemplary embodiment of the present invention.

As shown in FIG. 1, the entire system according to an exemplary embodiment of the present invention may be configured to include a communication network 100, a search advertisement system 200 performing auction and charging for a search advertisement based on time during which the search advertisement is published, an advertiser server (or an advertiser terminal device) 300, and a user terminal device 400, and a plurality of web servers 500 searching and providing contents according to a search keyword received from the user terminal device 400 according to the request of the user.

First, the communication network 100 may be configured regardless of a communication aspect such as a wired communication and a wireless communication, and may be various communication networks such as a local area network (LAN), a metropolitan area network (MAN), a wide area network (WAN), or the like. The communication network 100 described in the present invention may be the known World Wide Web (WWW).

According to the exemplary embodiment of the present invention, the search advertisement system 200 may serve to allow an advertiser to bid for a specific search keyword based on a time during which a search advertisement is published in performing the auction for the search advertisement.

Also, according to the exemplary embodiment of the present invention, the search advertisement system 200 may classify the search keywords and information on the advertiser (for example, information on a website of the advertiser) into predetermined categories according to characteristics thereof and permit or limit the bidding of the advertiser in consideration of the classified categories.

In addition, according to the exemplary embodiment of the present invention, the search advertisement system 200 may serve to publish the search advertisements corresponding to search keywords input by users.

Further, according to the exemplary embodiment of the present invention, the search advertisement system 200 may determine search advertisements of advertisers to be published corresponding to the search keywords input by the users according to the characteristics or accessing environments of the users accessing the web server 500. For example, the search advertisement system 200 may determine the search advertisements of the advertisers to be published corresponding to the search keywords input b the users according to regions in which the users accessing the web server 500 are located.

Furthermore, according to the exemplary embodiment of the present invention, the search advertisement system 200 may serve to store statistical information on the characteristics or the accessing environments of the users accessing the web server 500 for a predetermined time and determine a charging amount using the statistical information.

Moreover, according to the exemplary embodiment of the present invention, the search advertisement system 200 may serve to store statistical information on regions in which the users experiencing a published search advertisement by accessing the web server 500 are located and determine a charging amount using the statistical information.

According to the exemplary embodiment of the present invention, the advertiser server 300 may be a server including a function of allowing the advertiser to access the search advertisement system 200 and then communicate therewith. However, digital devices such as a personal computer (for example, a desktop computer, a notebook computer, or the like), a workstation, a personal digital assistance (PDA), a web pad, a mobile phone, or the like, may be used as a configuring device or an advertiser terminal device of the advertisement server 300 according to the present invention if they include a memory unit and a micro-processor to thereby have operational capability.

According to the exemplary embodiment of the present invention, the advertiser server 300 may serve to provide information on a search advertisement which the advertiser is to publish and a bidding price (for example, bidding prices for each time period and the total bidding price according to the bidding prices for each time period) to the search advertisement system 200 and to receive information on a bidding result from the search advertisement system 200. The advertiser server 300 may also be a homepage operating server operated by the advertiser in order to provide a product or a service.

Meanwhile, the user terminal device 400 according to the exemplary embodiment of the present invention may be a digital device including a function of allowing the user to access the web server 500 and then communicate therewith. Digital devices such as a personal computer (for example, a desktop computer, a notebook computer, or the like), a workstation, a PDA, a web pad, a mobile phone, or the like, may be used as the user terminal device 400 according to the present invention if they include a memory unit and a micro-processor to thereby have operational capability. In addition, the user terminal device 400 may further include a web browser (not shown) program allowing the user to receive contents by requiring the web server 500 for the contents.

According to the exemplary embodiment of the present invention, the web server 500 communicates with the search advertisement system 200 and/or the user terminal device 400. The web server 500 may include a web contents search engine (not shown) to thereby store a search keyword input by the user therein, search the contents corresponding to the search keyword, and provide a search result so that the user may browse the search result. For example, the web server 500 may be an operation server of an Internet search portal site. The contents provided as the search result may be various information on news, knowledge, game, community, or the like. The web content search engine may also be included in other arithmetic units or recording media rather than the web server 500, as needed. In addition, although FIG. 1 shows a case in which the search advertisement system 200 and the web server 500 are separately configured, the search advertisement system 200 may also be configured to be included in the web server 500 providing a search service in the case in which a search service and a search advertisement service are together provided, as needed, by those skilled in the art implementing the present invention.

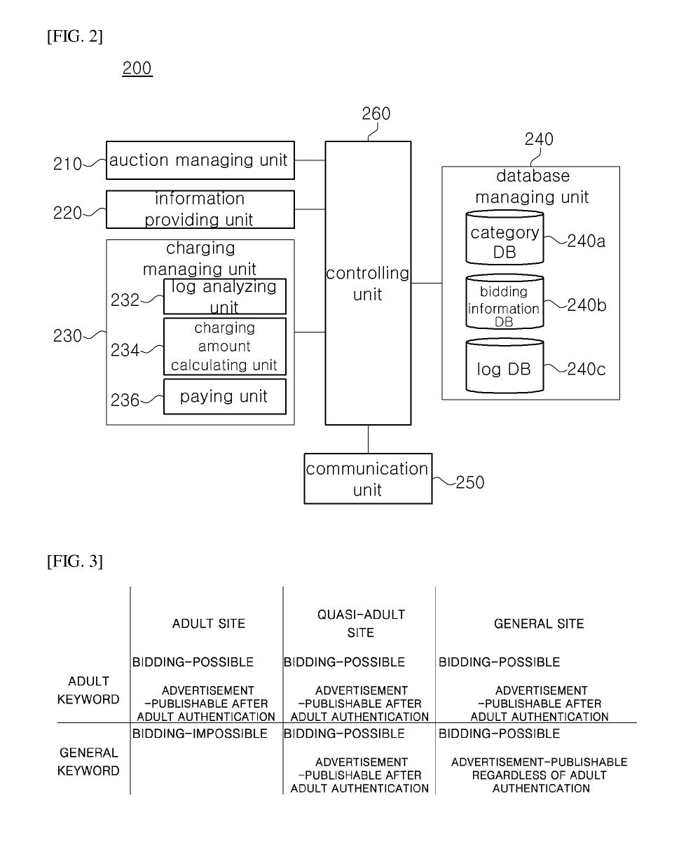

FIG. 2 is a view showing an internal configuration of a search advertisement system 200 according to an exemplary embodiment of the present invention in detail. Referring to FIG. 2, a search advertisement system 200 according to an exemplary embodiment of the present invention may be configured to include an auction managing unit 210, an advertisement providing unit 220, a charging processing unit 230, a database managing unit 240, a communicating unit 250, and a controlling unit 260. The charging processing unit 230 may include a log analyzing unit 232, a charging amount calculating unit 234, a paying unit 236, and the like. According to the exemplary embodiment of the present invention, at least some of the auction managing unit 210, the advertisement providing unit 220, the charging processing unit 230, the database managing unit 240, the communicating unit 250, and the controlling unit 260 may be program modules communicating with the advertiser server 300 and/or the user terminal device 400. These program modules may be included in a form of an operating system, an application program module and other program module in the search advertisement system 200, and be physically stored on several known storage devices. In addition, these program modules may also be stored in a remote storage device capable of communicating with the search advertisement system 200. Meanwhile, the program modules include a routine, a sub-routine, a program, an object, a component, a data structure, or the like, performing a specific task or executing a specific abstract data type as described below according to the present invention without being limited thereto.

First, the auction managing unit 210 according to the exemplary embodiment of the present invention may allow auction regarding a specific search keyword selected by the advertiser to be performed based on a time.

Here, the auction managing unit 210 may perform auction in a scheme of classifying search keywords for which the auction is made and information on advertisers participating in the auction into predetermined categories and permitting or limiting the bidding of the advertisers for the search keyword based on the classified categories.

In addition, when a bidding process ends, the auction managing unit 210 may also serve to allow N advertisers suggesting high bidding prices successfully bid for the search advertisement by the search keyword based on bidding prices of each advertiser.

Next, according to the exemplary embodiment of the present invention, the advertisement providing unit 220 serves to publish the search advertisements of the advertisers successfully bidden in the auction process corresponding to the search keyword input by the user. That is, the advertisement providing unit 220 may allow the search advertisements of the advertisers successfully bidden with respect to the search keyword to be published while providing a search result corresponding to the search keyword to the user terminal device 400.

More specifically, the advertisement providing unit 220 according to the exemplary embodiment of the present invention may determine publication positions and/or publication ranks of the search advertisements according to the ranks of bidding prices of each search advertisement, thereby making it possible to allow the search advertisement having a high bidding price to be published at a relatively advantageous position. In addition, the advertisement providing unit 220 according to the exemplary embodiment of the present invention may determine whether or not each search advertisement is published according to an advertisement publication time set for each search advertisement, thereby making it possible to stop the publication of the search advertisement for which the advertisement publication time expires and begin the publication of the search advertisement for which the advertisement publication time starts. Therefore, according to the exemplary embodiment of the present invention, a specific search advertisement has a rank of the bidding price changed for each of the several time periods during the publication thereof, such that it may be published at different positions for each time period.

Next, the charging processing unit 230 according to the exemplary embodiment of the present invention may perform charging with respect to the search advertisement based on the bidding information of the advertisers.

More specifically, the log analyzing unit 232 according to the exemplary embodiment of the present invention may calculate statistics such as a publication ratio of the search advertisement according to each situation based on a log database 240c to be described below.

In addition, the charging amount calculating unit 234 according to the exemplary embodiment of the present invention may serve to calculate a charging amount to be charged to the advertiser of the search advertisement based on the bidding information of the advertiser for the search advertisement and the statistics calculated by the log analyzing unit 232.

In addition, the paying unit 236 according to the exemplary embodiment of the present invention may perform payment for the calculated charging amount.

The database managing unit 240 according to the exemplary embodiment of the present invention may include a category database 240a having categorized information on the search keywords and the advertiser information stored therein, a bidding information database 240b having bidding information of the advertisers stored therein, and a log database 240c having historical information on publication of the search advertisements stored therein.

The communicating unit 250 according to the exemplary embodiment of the present invention serves to allow the search advertisement system 200 according to the present invention to communicate with external devices such as the advertiser server 300, the user terminal device 400, and the web server 500, and the like.

The controlling unit 260 according to the exemplary embodiment of the present invention serves to control flow of data among the auction managing unit 210, the advertisement providing unit 220, the charging processing unit 230, the database managing unit 240, and the communicating unit 250.

Although the databases storing the information for implementing the present invention therein have been classified into the category database 240a, the bidding information database 240b, and the log database 240c in the above-mentioned description, a configuration of the databases including these classifications may be changed, as needed, by those skilled in the art.

Finally, in the present invention, the database includes a database in a broad sense including computer file system based data recording, or the like, as well as a database in a narrow sense. It should be appreciated that even a set of simple operational processing histories may be included in the database described in the present invention if it may be searched to extract a predetermined data.

According to the exemplary embodiment of the present invention, the auction managing unit 210 may classify search keywords for which the auction is made and information on the advertisers participating in the auction into predetermined categories.

More specifically, the search keywords and the advertiser information may be classified using the search keywords or be classified according to attributes of users exposed to the advertiser information. For example, it may be assumed that the search keywords and the advertiser information are classified into adult/general, male/female/general, teens/20s/30s, or the like. Hereinafter, several exemplary embodiments of the present invention will be described with reference to a case in which the search keywords and the advertiser information are classified according to a standard of the adult/general, for convenience of explanation.

FIG. 3 is a view illustratively showing a classification standard of search keywords and advertiser information.

Referring to FIG. 3, it may be appreciated that the search keywords are classified into an “adult keyword” and a “general keyword” according to an attribute thereof and the advertiser information (a website of the advertiser) is classified into an “adult site,” a “quasi-adult site,” and a “general site”. In addition, it may be appreciated that a bidding policy and an advertisement publication policy for the search advertisement are changed according to these classifications.

According to the exemplary embodiment of the present invention, a group to which the website of the advertiser belongs may be input by the advertiser in a bidding process or be determined by the advertisement provider. However, what group the search keyword belongs to may be determined by the search advertisement system 200.

According to the exemplary embodiment of the present invention, the advertiser may participate in the bidding by specifying or selecting a search keyword for which an advertisement for his/her website is to be published and suggesting a bidding price and an advertisement publication time.

According to another exemplary embodiment of the present invention, the advertiser may participate in the bidding by specifying or selecting a search keyword for which an advertisement for his/her website is to be periodically published and suggesting a bidding price and an advertisement publication time, with respect to a periodical advertisement publication time specified by the auction managing unit 210. For example, in the case in which the auction managing unit 210 periodically specifies an advertisement publication time on a weekly basis, the advertiser may perform the bidding while changing or updating the search keyword for which the advertisement is to be periodically published on a weekly basis and the bidding price.

According to another exemplary embodiment of the present invention, the advertisement publication time specified by the auction managing unit 210 may have non-periodical characteristics. For example, after the auction managing unit 210 specifies an advertisement publication time, in the case in which a bidding participation ratio of advertisers is low, the auction managing unit 210 reduces the advertisement publication time to induce bidding participation of the advertisers, thereby making it possible to prevent the advertisement from being not sold. On the other hand, in the case in which the bidding participation ratio of the advertisers is high, the auction managing unit 210 increases the advertisement publication time, thereby making it possible to maximize profit.

Referring back to FIG. 3, it may be appreciated that all the advertisers may participate in the bidding with respect to the adult keyword; however, only the advertisers of the quasi-adult side and the general site may participate in the bidding with respect to the general keyword.

When the search keyword is input from the user, the auction managing unit 210 according to the exemplary embodiment of the present invention may select advertisements to be provided to the user based on the advertisement publication time and the bidding price suggested by the advertiser.

According to another exemplary embodiment of the present invention, when the search keyword is input from the user, the auction managing unit 210 may select advertisements to be provided to the user based on the bidding price suggested by the advertiser with respect to the advertisement publication time (for example, a day, a week, a month, or the like) periodically or non-periodically specified by the search advertisement system 200.

According to another exemplary embodiment of the present invention, ranks of the bidding prices are changed for each of the several time periods, such that a set of different advertisements may be selected for each time period, based on advertisement publication time information among bidding information of the advertisers. For example, the auction managing unit 210 may arrange a list of the search advertisements bidden by the advertisers according to ranks of the bidding prices suggested by the advertisers and select n advertisements having a high rank.

According to another exemplary embodiment of the present invention, the auction managing unit 210 may select advertisements in consideration of both of the bidding prices of the advertisers and advertisement effects which each advertiser is expected to accomplish. Here, the expected advertisement effects may be calculated using values such as click through rates (CTRs) of the search advertisements previously registered by each advertiser. The auction managing unit 210 may arrange the bidding list of the advertisers according to ranks of high bidding prices and expected advertisement effects and select advertisements having a high rank. According to the above-mentioned method, although an advertiser suggests a higher bidding price for a search advertisement, when it is expected that the advertisement effect of the corresponding search advertisement is not high, a case in which the search advertisement is published under a search advertisement of another advertiser suggesting a lower bidding price may also be generated.

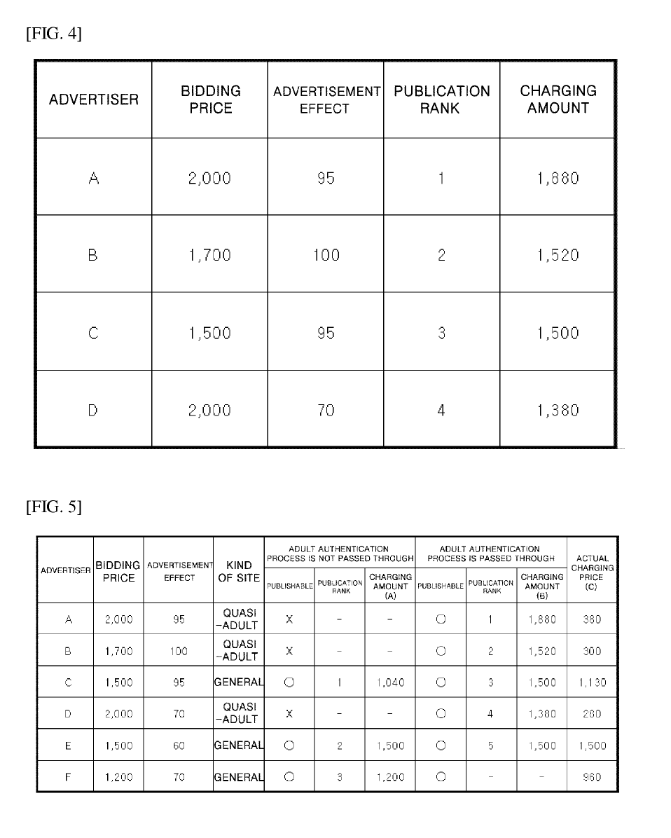

FIG. 4 is a view illustratively showing an aspect in which publication ranks of advertisements are determined according to bidding prices and expected advertisement effects of advertisers.

Referring to FIG. 4, it may be appreciated that although an advertiser D suggests bidding prices higher than those of advertisers B and C, the expected advertisement effect of a search advertisement of the advertiser D is low, such that the publication rank of the search advertisement is determined as a fourth rank.

In addition, the search advertisements to be provided to the user may be differently selected according to the search keyword and the advertiser information.

FIG. 5 is a view illustratively showing a result in which different search advertisements are published for each situation with respect to a single search keyword.

Referring to FIG. 5, it may be appreciated that published advertisements are differently selected according to whether or not a user passes through an adult authentication process. More specifically, it may be appreciated that in the case in which the user passes through the adult authentication process, the search advertisements to be published are selected only according to the bidding prices and the expected advertisement effects of the advertisers; however, in the case in which the user does not pass through the adult authentication process, search advertisements of advertisers A, B and D are not selected as the advertisements to be provided to the user regardless of the bidding prices and the expected advertisement effect. This is the reason that the advertisement publication policies for a general keyword may be changed according to whether or not the user passes through the adult authentication process and whether the website of the advertiser is the quasi-adult site or the general site, as shown in FIG. 3. Meanwhile, it may be appreciated that in the case in which the user passes through the adult authentication process, a search advertisement of an advertiser F has a bidding price and an expected advertisement effect lower than those of the search advertisements of other advertisers, such that it is not selected as an advertisement to be provided to the user; however, in the case in which the user does not pass through the adult authentication process, the search advertisements of the advertisers (that is, advertisers A, B, and D) of the quasi-adult site may not be published, such that the search advertisement of the advertiser F is selected as an advertisement at a third position to be provided to the user.

As described above, the present invention performs charging based on the CPT method. That is, the bidding price suggested by the advertiser in a bidding process may be used to calculate the charging amount for a publication time of the advertisement.

According to the exemplary embodiment of the present invention, the charging amount calculating unit 234 may calculate a cost to be charged to the advertiser only using the bidding price suggested by the advertiser in the bidding process.

According to another exemplary embodiment of the present invention, the charging amount calculating unit 234 may calculate the charging amount using a second price auction scheme, which is a known technology. Here, the second price auction scheme indicates a scheme in which a successful bidding is performed according to ranks of high bidding prices and a successful bidder pays only an advertisement cost according to a bidding price of a directly subordinated successful bidder. When the second price auction scheme is applied to the present invention, the charging amount per unit time for a specific advertiser may be set to an amount equal to the bidding price per unit time for an advertiser having a rank lower than that of the specific advertiser by one level or be set to an amount added thereto by a predetermined small amount.

According to another exemplary embodiment of the present invention, the charging amount calculating unit 234 may apply the second price auction scheme in a state in which the publication ranks of the advertisements are granted in consideration of both of the bidding prices and the expected advertisement effects of the advertisers as described above. In this case, the charging amount per unit time for a specific advertiser may be set to an amount equal to a value obtained by dividing a value obtained by multiplying a bidding price and an expected advertisement effect of an advertiser having a rank lower than that of the specific advertiser by one level by an expected advertisement effect of the specific advertiser or be set to an amount added by a predetermined small amount thereto.

A charging amount A and a charging amount B shown in FIG. 5 indicate charging amounts calculated after the second price auction scheme is applied in consideration of the bidding prices and the expected advertisement effects of the advertisers. According to the present invention, as shown in FIG. 5, the publication ranks of the advertisements may be changed according to whether or not the user passes through the adult authentication process. Therefore, although the advertiser suggests a single bidding price to thereby be successfully bidden, the charging amount may be changed according to an adult authentication ratio of the user. For example, it may be appreciated that although an advertiser C suggests 1,500 won to thereby be successfully bidden for the advertisement, a charging amount per unit time is 1040 won in the case in which the user does not pass through the adult authentication process; however, it is 1500 won in the case in which the user passes through the adult authentication process.

As such, although the advertiser purchases a single search advertisement, the charging amount calculating unit 234 may set different charging amounts according to a situation in which the search advertisement is published. As described above, since the CPT charging method is a method of charging a cost to the advertiser only based on the publication possibility of the advertisement for a predetermined time, a process of deducing a reasonable charging amount is required.

To this end, according to the exemplary embodiment of the present invention, the log database 240c has histories on requests and responses among the search advertisement system 200, the user terminal device 400, and the web server 500 stored therein, and the log analyzing unit 232 analyzes data stored in the log database 240c to thereby calculate statistics for a publication ratio of the search advertisement according to each situation. For example, in the case of FIG. 5, the log analyzing unit 232 may also analyze the data stored in the log database 240c to thereby calculate statistics that the ratio of the case in which the user does not pass through the adult authentication process is 80% and the ratio of the case in which the user passes through the adult authentication process is 20%, among all the searches performed by the user.

According to the exemplary embodiment of the present invention, the data stored in the log database 240c includes data on a time during which the search advertisement successfully bidden to the advertiser through auction is published, and the log analyzing unit 232 may calculate statistics for a publication ratio of the search advertisement according to each situation using the data on the time.

The charging amount calculating unit 234 according to the exemplary embodiment of the present invention may calculate a final charging amount using a scheme of applying the ratios calculated by the log analyzing unit 232 to the charging amounts calculated for each advertisement publication situation and calculating a weighted sum thereof. For example, in an example of FIG. 5, when the ratio of the case in which the user does not pass the adult authentication process is 80% and the ratio of the case in which the user passes the adult authentication process is 20%, in the case of an advertiser C of a general site, a weight of 0.8 is provided to 1,040 won (a charging amount per unit time) and a weight of 0.2 is provided to 1,500 won (a charging amount per unit time), such that a final charging amount per unit time becomes 1,132 won (1,130 won by rounding off); and in the case of an advertiser D of a quasi-adult site, since an advertisement is published only in the case in which the user passes through the adult authentication process, a weight of 0.2 is provided to 1,380 won (a charging amount per unit time), such that that a final charging amount per unit time becomes 276 won (280 won by rounding off).

Hereinabove, although a method for calculating a final charging amount has been described with reference to the case in which when the advertisers suggest a single bidding price, the charging amount is calculated based on a predetermined ratio according to each situation, the above-mentioned method for calculating a final charging amount may also be applied to the case in which the advertisers suggest separate bidding prices for each situation.

In addition, although the present invention has been described with reference to the case in which different advertisement publication policies are applied according to whether or not the user passes through the adult authentication process, the technical idea of the present invention may also be applied to the case in which the advertisement publication policies are changed according to various conditions such as a sex, an age (an age group), or the like.

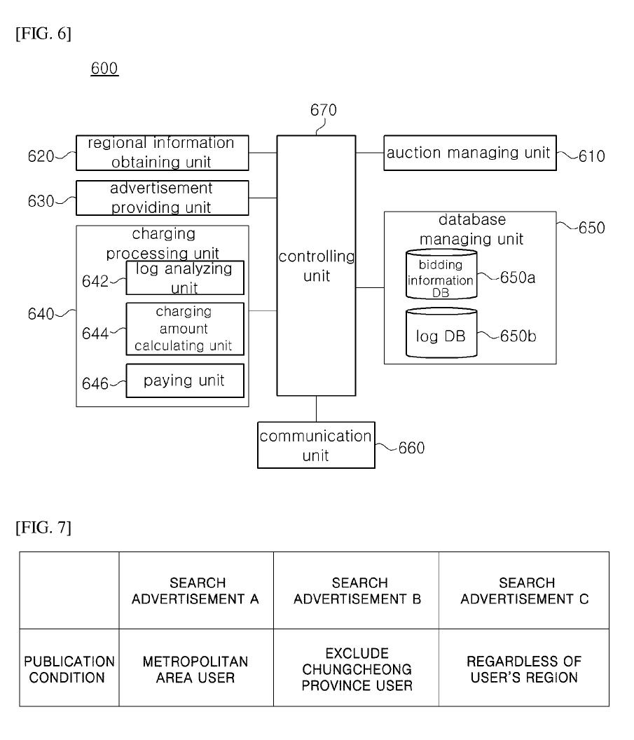

FIG. 6 is a view showing an internal configuration of a search advertisement system 600 according to an exemplary embodiment of the present invention in detail. Referring to FIG. 6, a search advertisement system 600 according to an exemplary embodiment of the present invention may be configured to include an auction managing unit 610, a regional information obtaining unit 620, an advertisement providing unit 630, a charging processing unit 640, a database managing unit 650, a communicating unit 660, and a controlling unit 670. The charging processing unit 640 may include a log analyzing unit 642, a charging amount calculating unit 644, a paying unit 646, and the like. According to the exemplary embodiment of the present invention, at least some of the auction managing unit 610, the regional information obtaining unit 620, the advertisement providing unit 630, the charging processing unit 640, the database managing unit 650, the communicating unit 660, and the controlling unit 670 may be program modules communicating with the advertiser server 300 and/or the user terminal device 400. These program modules may be included in a form of an operating system, an application program module and other program module in the search advertisement system 600, and be physically stored on several known storage devices. In addition, these program modules may also be stored in a remote storage device capable of communicating with the search advertisement system 600. Meanwhile, the program modules include a routine, a sub-routine, a program, an object, a component, a data structure, or the like, performing a specific task or executing a specific abstract data type as described below according to the present invention without being limited thereto.

First, the auction managing unit 610 according to the exemplary embodiment of the present invention may allow auction regarding a specific search keyword selected by the advertiser to be performed based on a time.

Here, the auction managing unit 610 may perform auction in consideration of both of the bidding information of advertisers participating in the auction and regional conditions of users receiving search advertisements of the advertisers.

In addition, when a bidding process ends, the auction managing unit 610 may also serve to allow N advertisers suggesting high bidding prices to be a successful bid for the search advertisement by the search keyword based on bidding prices of each advertiser.

Next, the regional information obtaining unit 620 according to the exemplary embodiment of the present invention may serve to obtain information on regions in which users accessing the search advertisement system 600 are located. A specific process of obtaining the regional information of the user in the regional information obtaining unit 620 will be described.

Next, according to the exemplary embodiment of the present invention, the advertisement providing unit 630 serves to receive the regional information of the user from the regional information obtaining unit 620 and publish a search advertisement matched to the regional information of the user among search advertisements of advertisers successfully bidden in the auction process with respect to the search keyword input by the user. That is, the advertisement providing unit 630 may allow the search advertisements of the advertisers matched to the regional information of the user to be together published in providing a search result corresponding to the search keyword to the user terminal device 400.

The advertisement providing unit 630 according to the exemplary embodiment of the present invention may determine publication positions and/or publication ranks of the search advertisements according to the ranks of the bidding prices of each search advertisements, thereby making it possible to allow the search advertisement having a high bidding price to be published at a relatively advantageous position. In addition, the advertisement providing unit 630 according to the exemplary embodiment of the present invention may determine whether or not each search advertisement is published according to an advertisement publication time set for each search advertisement, thereby making it possible to stop the publication of the search advertisement for which the advertisement publication time expires and begin the publication of the search advertisement for which the advertisement publication time starts. Therefore, according to the exemplary embodiment of the present invention, a specific search advertisement has a rank of the bidding price changed for each of the several time periods during the publication thereof, such that it may be published at different positions for each time period.

Next, the charging processing unit 640 according to the exemplary embodiment of the present invention may perform charging with respect to the search advertisement of which the publication is finished based on bidding information of the advertisers.

More specifically, the log analyzing unit 642 according to the exemplary embodiment of the present invention may calculate statistics such as a publication ratio of the search advertisement according to each situation based on a log database 650b to be described below.

In addition, the charging amount calculating unit 644 according to the exemplary embodiment of the present invention may serve to calculate a charging amount to be charged to the advertiser of the search advertisement based on the bidding information of the advertiser for the search advertisement and the statistics calculated by the log analyzing unit 642.

In addition, the paying unit 646 according to the exemplary embodiment of the present invention may perform payment for the calculated charging amount.

The database managing unit 650 according to the exemplary embodiment of the present invention may include a bidding information database 650a having bidding information of the advertisers stored therein, and a log database 650b having historical information on publication of the search advertisements stored therein.

The communicating unit 660 according to the exemplary embodiment of the present invention serves to allow the search advertisement system 600 according to the present invention to communicate with external devices such as the advertiser server 300, the user terminal device 400, and the web server 500, and the like.

The controlling unit 670 according to the exemplary embodiment of the present invention serves to control flow of data among the auction managing unit 610, the regional information obtaining unit 620, the advertisement providing unit 630, the charging processing unit 640, the database managing unit 650, and the communicating unit 660.

Although the database storing the information for implementing the present invention therein have been classified into the bidding information database 650a and the log database 650b in the above-mentioned description, a configuration of the databases including these classifications may be changed by those skilled in the art, as needed.

The advertiser may participate in the bidding by specifying or selecting a search keyword for which an advertisement for his/her website is to be published and suggesting a bidding price and an advertisement publication time.

When the search keyword is input from the user, the auction managing unit 610 according to the exemplary embodiment of the present invention may select advertisements to be provided on the advertisement publication time and the bidding price suggested by the advertiser. Since the present invention may adopt the above-mentioned CPT method, ranks of the bidding prices are changed for each of the several time periods, such that a set of different advertisements may be selected for each time period, based on advertisement publication time information among bidding information of the advertisers. For example, the auction managing unit 610 may arrange a list of the search advertisements bidden by the advertisers according to ranks of the bidding prices suggested by the advertisers and select n advertisements having a high rank.

According to another exemplary embodiment of the present invention, the auction managing unit 610 may select advertisements in consideration of both of the bidding prices of the advertisers and advertisement effects which each advertiser is expected to accomplish. Here, the expected advertisement effects may be calculated using values such as click through rates (CTRs) of the search advertisements previously registered by each advertiser. The auction managing unit 610 may arrange the bidding list of the advertisers according to ranks of high bidding prices and expected advertisement effects and select n advertisements having a high rank. According to the above-mentioned method, although an advertiser suggests a higher bidding price for a search advertisement, when it is expected that the advertisement effect of the search advertisement is not high, a case in which the search advertisement is published under a search advertisement of other advertiser suggesting a lower bidding price may also be generated.

According to the exemplary embodiment of the present invention, the auction managing unit 610 may consider both of bidding information of an advertiser participating in the auction and information on a regional condition of a user to receive a search advertisement of the advertiser. For example, a search advertisement of a specific advertiser may be provided to all users regardless of a region in which the users are located or be provided to users located in a specific region such as a metropolitan area, or the like.

The information on the regional condition may be directly input by an advertiser in a process in which he/she participates in the auction or may be automatically obtained by the auction managing unit 610 based on information of the advertiser (for example, an address of a store operated by the advertiser).

FIG. 7 is a view showing an example of defining a regional condition in which search advertisements of advertisers are published. Referring to FIG. 7, as a scheme of defining a regional condition in which a search advertisement is published, a scheme of publishing the search advertisement only to users located in a specific region, a scheme of publishing the search advertisement users excepting for users located in a specific region, a scheme of publishing the search advertisement regardless of regional information of users, or the like may be used.

According to the exemplary embodiment of the present invention, the regional information obtaining unit 620 obtains information on a region in which a user accessing the search advertisement system 600 is located, and the advertisement providing unit 630 receives the regional information of the user from the regional information obtaining unit 620 and then publishes a search advertisement matched to the regional information of the user among search advertisements of advertisers corresponding to a search keyword input by the user.

A process of obtaining the information on the region in which the user is located in the regional information obtaining unit 620 according to the exemplary embodiment of the present invention may be performed in various schemes.

According to the exemplary embodiment of the present invention, the regional information obtaining unit 620 may determine the region in which the user is located by analyzing an Internet protocol (IP) address of the user. More specifically, the regional information obtaining unit 620 may determine the region in which the user is located by using an IP usage organization information search function provided from a domain registration authority, or the like, such as Whois, Inc., or the like. That is, the regional information obtaining unit 620 may obtain information on the region in which the user terminal device 400 is located by obtaining the IP address of the user terminal device 400 inputting the search keyword and applying for an IP usage organization information search service using the obtained IP address.

In addition, as another method of determining a region in which a user is located using an IP address, a method of using a technology disclosed in Korean Patent Laid-Open Publication No. 2007-23941 filed on Aug. 25, 2005 by Daum Communications, Inc. and published on Mar. 2, 2007 may be used. Korean Patent Laid-Open Publication No. 2007-23941 discloses a technology in which address information input by a user performing electronic commerce for the delivery of a product and an IP address of the user are connected with each other to thereby build a database and regional information corresponding to the IP address is obtained using the database.

According to the exemplary embodiment of the present invention, the regional information obtaining unit 620 may determine the region in which the user is located by being linked to a system of a communication service provider subscribed by the user. For example, when the user terminal device is a device such as a desktop computer, a notebook computer, or the like, the regional information obtaining unit 620 may determine the region in which the user is located by being linked to a system of an Internet service provider (ISP). That is, when a user applies for a service to the ISP in order to use an Internet, address information, or the like, of the user may be provided to the search advertisement system 600 according to the exemplary embodiment of the present invention to thereby be stored in a predetermined database (not shown), and the regional information obtaining unit 620 may obtain the regional information of the user based on the database. In addition, when the user terminal device is a mobile communication device, the regional information obtaining unit 620 may also use location information of the mobile communication device stored in a home location register (HLR) and/or a visitor location register (VLR) of a mobile communication company by being linked to a mobile communication company system.

According to the exemplary embodiment of the present invention, the regional information obtaining unit 620 may determine the region in which the user is located based on log-in information of the user. For example, the regional information obtaining unit 620 may reference address information input in a process in which the user subscribes to the search advertisement system 600 as a member thereof.

According to the exemplary embodiment of the present invention, the user terminal device 400 may include a global positioning system (GPS) receiver and transmit location information calculated according to a signal received through a GPS satellite to the regional information obtaining unit 620, thereby making it possible to allow the location information to be used.

According to the exemplary embodiment of the present invention, the regional information obtaining unit 620 may estimate the regional information of the user by analyzing a search keyword input by the user. For example, when a search keyword including a specific region name among search keywords input by the user occupies a ratio of a predetermined degree or more, the specific region may be estimated as a region in which the user is located or a region at which the user mainly acts.

The advertisement providing unit 630 according to the exemplary embodiment of the present invention extracts a search advertisement matched to the search keyword input by the user and the regional information of the user obtained by the regional information obtaining unit 620 and provides the extracted search advertisement to the user. Therefore, although two users input the same search keyword, different search advertisements may be published according to the regional information of the two users.

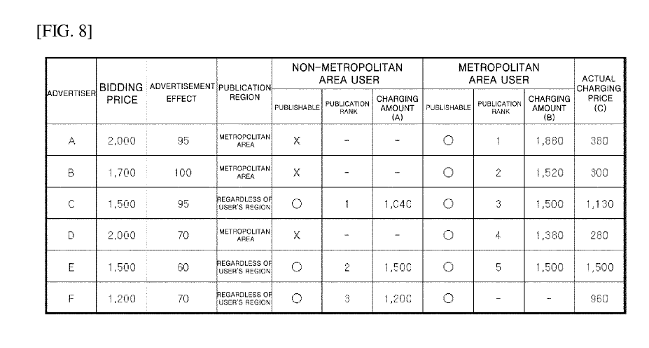

FIG. 8 is a view illustratively showing a publication result of search advertisements provided corresponding to a search keyword input by a user or regional information of the user.

Although FIG. 8 shows a case in which regional information of users are simply divided into a metropolitan area and a non-metropolitan area, this division is only an example for assisting in the understanding of the present invention. The regional information of the users may be actually sub-divided into a city, a district, a dong, or the like.

Referring to FIG. 8, it may be appreciated that published advertisements are differently selected according to whether or not a region in which a user is located is a metropolitan area. More specifically, it may be appreciated that in the case in which the user is located in a metropolitan area, search advertisements of advertisers A, B, C, D, and E are published; however, in the case in which the user is located in a non-metropolitan area, search advertisements of advertisers A, B, and D are not selected as an advertisement to be provided to a user regardless of bidding prices. This is the reason that the search advertisements of the advertisers A, B, and D are set to be published only to the users of a metropolitan area, as shown in FIG. 8. Meanwhile, it may be appreciated that in the case in which the user is located in the metropolitan area, a search advertisement of an advertiser F has a bidding price lower than those to search advertisements of other advertisers, such that it is not selected as an advertisement to be published to the user; however, in the case in which the user is located in the non-metropolitan area, the search advertisements of the advertisers A, B, and D may not be published, such that the search advertisement of the advertiser F is selected as an advertisement of a third rank to be provided to the user.

As described above, the present invention performs charging based on the CPT method. That is, the bidding price suggested by the advertiser in a bidding process may be used to calculate the charging amount for a publication time of the advertisement.

According to the exemplary embodiment of the present invention, the charging amount calculating unit 644 may calculate a cost to be charged to the advertiser only with the bidding price suggested by the advertiser in the bidding process.

According to another exemplary embodiment of the present invention, the charging amount calculating unit 644 may calculate the charging amount using a second price auction scheme, which is a known technology. Here, the second price auction scheme indicates a scheme in which a successful bidding is performed according to ranks of high bidding prices and a successful bidder pays only an advertisement cost according to a bidding price of a directly subordinated successful bidder. When the second price auction scheme is applied to the present invention, the charging amount per unit time for a specific advertiser may be set to an amount equal to the bidding price per unit time for an advertiser having a rank lower than that of the specific advertiser by one level or be set to an amount added thereto by a predetermined small amount.

According to another exemplary embodiment of the present invention, the charging amount calculating unit 644 may apply the second price auction scheme in a state in which the advertisement publication ranks are granted in consideration of both of the bidding prices and the expected advertisement effects of the advertisers as described above. In this case, the charging amount per unit time for a specific advertiser may be set to a amount equal to a value obtained by dividing a value obtained by multiplying a bidding price and an expected advertisement effect of an advertiser having a rank lower than that of the specific advertiser by one level by an expected advertisement effect of the specific advertiser or be set to an amount added thereto by a predetermined small amount.

A charging amount A and a charging amount B shown in FIG. 8 indicate charging amounts calculated after the second price auction scheme is applied in consideration of the bidding prices and the expected advertisement effects of the advertisers. According to the present invention, as shown in FIG. 8, the publication ranks of the advertisements may be changed according to the regional information of the user. Therefore, although the advertiser suggests a single bidding price to thereby be successfully bidden, the charging amounts may be changed according to a regional information ratio of the user. For example, it may be appreciated that although an advertiser C suggests 1,500 won to thereby be successfully bidden for the advertisement, a charging amount per unit time is 1040 won in the case in which the user is located in the non-metropolitan area; however, it is 1500 won in the case in which the user is located in the metropolitan area.

As such, although the advertiser purchases a single search advertisement, the charging amount calculating unit 644 may set different charging amounts according to the regional information of the user inputting the search keyword. As described above, since the CPT charging method is a method of charging a cost to the advertiser only based on the publication possibility of the advertisement for a predetermined time, a process of deducing a final reasonable charging amount is required.

To this end, according to the exemplary embodiment of the present invention, the log database 650b has histories on requests and responses among the search advertisement system 600, the user terminal device 400, and the web server 500 stored therein, and the log analyzing unit 642 analyzes data stored in the log database 650b to thereby calculate statistics for an occupying ratio of the regional information of the users that have performed the search. For example, in the case of FIG. 8, the log analyzing unit 642 may also analyze the data stored in the log database 650 b to thereby calculate statistics that the ratio of the case in which the user is located in the non-metropolitan area is 80% and the ratio of the case in which the user is located in the metropolitan area is 20%, among all the searches performed by the user.

According to the exemplary embodiment of the present invention, the data stored in the log database 650b includes data on a time during which the search advertisement successfully bidden to the advertiser through auction is published, and the log analyzing unit 642 may calculate statistics for an occupying ratio of the regional information of the users that have performed the search using the data on the time.

The charging amount calculating unit 644 according to the exemplary embodiment of the present invention may calculate a final charging amount using a scheme of applying the ratios calculated by the log analyzing unit 642 to the charging amounts calculated for each regional information and calculating a weighted sum thereof. For example, in an example of FIG. 8, when the ratio of the case in which the user is located in the non-metropolitan area is 80% and the ratio of the case in which the user is located in the metropolitan area is 20%, in the case of an advertiser C that does not defines a target to provide the search advertisement, a weight of 0.8 is provided to 1,040 won (a charging amount per unit time) and a weight of 0.2 is provided to 1,500 won (a charging amount per unit time), such that a final charging amount per unit time becomes 1,132 won (1,130 won by rounding off); and in the case of an advertiser D that defines the target to provide the search advertisement as users of the metropolitan area, since the search advertisement is published only to the users of the metropolitan area, a weight of 0.2 is provided to 1,380 won (a charging amount per unit time), such that that a final charging amount per unit time becomes 276 won (280 won by rounding off).

With the present invention, a new search advertisement model allowing an advertisement cost to be determined based on a publication ratio of the search advertisement under each situation in the case in which the search advertisement is published according to different policies under different situations may be provided.

According to the present invention, trust relationship between the advertiser and the advertisement provider is enhanced, thereby making it possible to maintain and expand a search advertisement market and increase profit of the advertisement provider.

The exemplary embodiments according to the present invention described above are implemented in a form of program commands capable of being performed through various computer components to thereby be recordable in a computer-readable recording medium. The computer-readable recording medium may include program commands, data files, data structures, or the like, alone or in combination. The program command recorded in the computer-readable recording medium may be designed and configured especially for the present invention, or may be known to those skilled in a field of computer software. Example of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially configured to store and perform program commands such as a ROM, a RAM, a flash memory, or the like. Examples of the program commands may include machine language codes such as being made by compilers as well as high-level language codes capable of being executed by computers using interpreters or the like. The hardware device may be configured to be operated as one or more software modules in order to perform the process according to the present invention, and vice versa.

Hereinabove, although the present invention is described by specific matters such as concrete components, and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the sprit of the present invention should not be limited to the above-described exemplary embodiments, and the following claims as well as all modified equally or equivalently to the claims are intended to fall within the scope and spirit of the invention.

What is claimed is:

1. A method for performing charging for a search advertisement based on a publication ratio, the method comprising:
calculating the publication ratio of the search advertisement to a plurality of users, the publication ratio substantially indicating a ratio between the number of search advertisement published to users recognized as belonging to a first group and the number of search advertisement published to users recognized as belonging to a second group;
calculating each of the charging amounts for the search advertisements published to the users recognized as belonging to the first group and the search advertisement published to the users recognized as belonging to the second group;
calculating a final charging amount based on the publication ratio and each of the calculated charging amounts; and
performing charging for an advertiser of the search advertisement using the final charging amount.

2. The method of claim 1, wherein the search advertisement is differently published to the plurality of users based on information of the advertiser.

3. The method of claim 2, wherein the information of the advertiser comprises information depending on whether a website of the advertiser is an adult site, a quasi-adult site, or a general site.

4. The method of claim 1, wherein the first group and the second group are determined according to whether or not the user passes through an adult authentication process in which the search advertisement is published to the users.

5. The method of claim 1, wherein the first group and the second group are determined according to ages or sexes of the users.

6. The method of claim 1, wherein at least one of the charging amounts for the search advertisement published to the users recognized as belonging to the first group and the search advertisement published to the users recognized as belonging to the second group is determined based on a bidding price per unit time for the search advertisement of the advertiser.

7. The method of claim 6, wherein at least one of the charging amounts for the search advertisement published to the users recognized as belonging to the first group and the search advertisement published to the users recognized as belonging to the second group is determined according to a second price auction scheme.

8. The method of claim 1, wherein at least one of the charging amounts for the search advertisement published to the users recognized as belonging to the first group and the search advertisement published to the users recognized as belonging to the second group is determined based on bidding prices divided by the advertiser.

9. The method of claim 1, wherein the calculating of the final bidding price comprises adding all of the values obtained by multiplying each of the calculated charging amounts by a publication ratio corresponding thereto.

10. The method of claim 9, wherein the calculating of the final bidding price comprises time during which the search advertisement is published.

11. A method for performing charging for a search advertisement based on a publication ratio, the method comprising:
calculating the publication ratio of the search advertisement to a plurality of users, the publication ratio substantially indicating a ratio between the number of search advertisement published to users recognized as belonging to a specific group and recognized as not belonging to the specific group and the total publication number of search advertisement;
calculating the charging amounts for the search advertisement published to the users recognized as belonging to the specific group and recognized as not belonging to the specific group;
calculating a final charging amount based on the publication ratio and the calculated charging amounts; and
performing charging for an advertiser of the search advertisement using the final charging amount.

12. A system for performing charging for a search advertisement based on a publication ratio, the system comprising:
a log analyzing unit configured to calculate the publication ratio of the search advertisement to a plurality of users, the publication ratio substantially indicating a ratio between s the number of search advertisement published to users recognized as belonging to a first group and the number of search advertisement published to users recognized as belonging to a second group;
a charging amount calculating unit configured to calculate each of the charging amounts for the search advertisement published to the users recognized as belonging to the first group and the search advertisement published to the users recognized as belonging to the second group and calculating a final charging amount based on the publication ratio and each of the calculated charging amounts; and
a charging processing unit configured to perform charging for an advertiser of the search advertisement using the final charging amount.

13. The system of claim 12, wherein the search advertisement is differently published to the plurality of users based on information of the advertiser.

14. The system of claim 13, wherein the information of the advertiser comprises information depending on whether a website of the advertiser is an adult site, a quasi-adult site, or a general site.

15. The system of claim 12, wherein the first group and the second group are determined according to whether or not the user passes through an adult authentication process in which the search advertisement is published to the users.

16. The system of claim 12, wherein the first group and the second group are determined according to ages or sexes of the users.

17. The system of claim 12, wherein at least one of the charging amounts for the search advertisement published to the users recognized as belonging to the first group and the search advertisement published to the users recognized as belonging to the second group is determined based on a bidding price per unit time for the search advertisement of the advertiser.

18. The system of claim 17, wherein at least one of the charging amounts for the search advertisement published to the users recognized as belonging to the first group and the search advertisement published to the users recognized as belonging to the second group is determined according to a second price auction scheme.

19. The system of claim 12, wherein at least one of the charging amounts for the search advertisement published to the users recognized as belonging to the first group and the search advertisement published to the users recognized as belonging to the second group is determined based on bidding prices divided by the advertiser.

20. The system of claim 12, wherein the charging amount calculating unit is further configured to perform a process of adding all of the values obtained by multiplying each of the calculated charging amounts by a publication ratio corresponding thereto.

21. The system of claim 20, wherein the charging amount calculating unit is further configured to consider a time during which the search advertisement is published.

22. A system for performing charging for a search advertisement based on a publication ratio, the system comprising:
a log analyzing unit configured to calculate the publication ratio of the search advertisement to a plurality of users, the publication ratio substantially indicating a ratio between the number of search advertisement published to users recognized as belonging to a specific group and recognized as not belonging to the specific group and the total publication number of search advertisement;
a charging amount calculating unit configured to calculate the charging amounts for the search advertisement published to the users recognized as belonging to the specific group and recognized as not belonging to the specific group and calculating a final charging amount based on the publication ratio and the calculated charging amounts; and
a charging processing unit configured to perform charging for an advertiser of the search advertisement using the final charging amount.

23. A method for performing charging for a search advertisement based on a publication ratio, the method comprising:
calculating the publication ratio of the search advertisement to a plurality of users, the publication ratio substantially indicating a ratio between the number of search advertisement published to users recognized as being located in a first region and the number of search advertisement published to users recognized as being located in a second region;
calculating each of the charging amounts for the search advertisement published to the users recognized as being located in the first region and the search advertisement published to the users recognized as being located in the second region;
calculating a final charging amount based on the publication ratio and each of the calculated charging amounts; and
performing charging for an advertiser of the search advertisement using the final charging amount.

24. The method of claim 23, wherein the search advertisement is differently published to the plurality of users in consideration of an advertisement publication condition obtained based on information on the advertiser.

25. The method of claim 24, wherein the advertisement publication condition is information on a region in which users capable of receiving the search advertisement are located.

26. The method of claim 23, wherein at least one of the charging amounts for the search advertisement published to the users recognized as being located in the first region and the search advertisement published to the users recognized as being located in the second region is determined based on a bidding price per unit time for the search advertisement of the advertiser.

27. The method of claim 26, wherein at least one of the charging amounts for the search advertisement published to the users recognized as being located in the first region and the search advertisement published to the users recognized as being located in the second region is determined according to a second price auction scheme.

28. The method of claim 23, wherein the calculating of the final charging amount includes adding all of the values obtained by multiplying each of the calculated charging amounts by a publication ratio corresponding thereto.

29. The method of claim 23, wherein whether the respective users are located in the first region or the second region is determined by at least one of:
regional information obtained using IP addresses of user terminal devices;
regional information provided from a system of a communication service provider;
regional information included in log-in information of the users;
position information received from the user terminal devices; and
regional information obtained based on search keywords previously input by the users.

30. A system for performing charging for a search advertisement based on a publication ratio, the system comprising:
a log analyzing unit configured to calculate the publication ratio of the search advertisement to a plurality of users, the publication ratio substantially indicating a ratio between the number of search advertisement published to users recognized as being located in a first region and the number of search advertisement published to users recognized as being located in a second region;
a charging amount calculating unit configured to calculate each of the charging amounts for the search advertisement published to the users recognized as being located in the first region and the search advertisement published to the users recognized as being located in the second region and calculating a final charging amount based on the publication ratio and each of the calculated charging amounts; and
a charging processing unit configured to perform charging for an advertiser of the search advertisement using the final charging amount.
